(19) United States
(12) Patent Application Publication
(10) Pub. No.: US 2014/0278017 A1
(43) Pub. Date: Sep. 18, 2014

(54) APPARATUS, SYSTEM, AND METHOD FOR REDUCING ENGINE KNOCK

(71) Applicant: Cummins IP, Inc., Columbus, IN (US)

(72) Inventors: J. Steven Kolhouse, Columbus, IN (US); Vivek Sujan, Columbus, IN (US); Thomas Yonushonis, Columbus, IN (US)

(73) Assignee: Cummins IP, Inc., Columbus, IN (US)

(21) Appl. No.: 14/188,138

(22) Filed: Feb. 24, 2014

Related U.S. Application Data
(60) Provisional application No. 61/784,650, filed on Mar. 14, 2013.

(51) Int. Cl. F02P 5/15

(52) U.S. Cl. CPC F02P 5/15
USPC 701/111

(57) ABSTRACT

A system and method for reducing engine knock associated with an internal combustion engine. An exhaust gas recirculation sub-system is fluidly connected to the internal combustion engine and includes a compressor and an exhaust gas storage tank fluidly connected to the compressor. In response to measuring that engine knock is occurring, compressed exhaust gas is injected from the exhaust gas storage tank into a combustion chamber of the internal combustion engine.

### CROSS-REFERENCE TO RELATED APPLICATIONS

The present application claims priority to U.S. Provisional Patent Application No. 61/784,650, filed Mar. 14, 2013 and the contents of which are incorporated herein by reference.

### BACKGROUND

Emissions regulations for internal combustion engines have become more stringent over recent years. Environmental concerns have motivated the implementation of stricter emission requirements for internal combustion engines throughout much of the world. Engine manufacturers are therefore striving to create fuel efficient engines that emit fewer harmful pollutants. In other words, engines are required to produce more power and at the same time emit fewer pollutants.

Consequently, engines are being designed to operate at the threshold of “engine knock” in order to extract the most energy from the power stroke of a cylinder cycle in an internal combustion engine. Engine knock occurs when pockets of air and fuel combust outside the controlled combustion profile of spark-ignited engines. For example, the combustion reaction in spark-ignited engines generally propagates outward from the spark event and expands substantially uniformly throughout the volume of the combustion chamber. However, when pockets of air and fuel spontaneously combust due to excessive heat and/or pressure in the chamber, the progression of the combustion reaction is retarded, thus limiting the work derived from the expanding gases in the cylinder. Engine knock also may cause damage to the engine cylinders because the temperature and pressure generated in the cylinder when one of the pockets spontaneously combusts may be excessively high.

Conventional engine systems have attempted to address engine knock in a number of ways. For example, conventional engine systems often retard spark-ignition timings when engine knock is detected or predicted, thus sacrificing fuel economy and/or performance in order to prevent potentially damaging engine knock. In other circumstances, engine systems may adjust the temperature and/or pressure of the intake air entering the cylinders, thus reducing the likelihood and intensity of engine knock.

However, this strategy fails to significantly affect engine knock because the lag-time involved with changing the temperature and pressure of intake air is too great. In other words, once engine knock is detected or predicted, the temperature and pressure components do not have sufficient time to significantly alter the temperature and/or pressure to prevent engine knock.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic block diagram of a system for reducing engine knock in an internal combustion engine, according to one embodiment;

FIG. 2 is a schematic block diagram of a controller apparatus for reducing engine knock in an internal combustion engine, according to one embodiment; and

FIG. 3 is a schematic flowchart diagram of a method for reducing engine knock in an internal combustion engine, according to one embodiment.

### SUMMARY

A system and method for reducing engine knock associated with an internal combustion engine is provided. An exhaust gas recirculation sub-system is fluidly connected to the internal combustion engine and includes a compressor and an exhaust gas storage tank fluidly connected to the compressor. In response to measuring or predicting that engine knock is occurring, compressed exhaust gas is injected from the exhaust gas storage tank into a combustion chamber of the internal combustion engine.

### DETAILED DESCRIPTION

The subject matter of the present application has been developed in response to the present state of the art, and in particular, in response to the problems and needs in the art that have not yet been fully solved by currently available engine systems. One problem associated with prior art engine systems is the difficulty of preventing engine knock. Accordingly, the subject matter of the present application has been developed to provide an engine system that utilizes stored exhaust gas to prevent engine knock, thus overcoming at least some shortcomings of the prior art systems.

FIG. 1 is a schematic block diagram of a system 100 for reducing engine knock in an internal combustion engine 110, according to one embodiment. The system 100 includes an internal combustion engine 110, an exhaust gas recirculation sub-system 120, and a controller apparatus 130, among other components. The internal combustion engine 110 includes an intake manifold 112, combustion chambers 114, and an exhaust manifold 116. The exhaust gas recirculation sub-system 120, according to one embodiment, includes a separation component 122, a compressor 124, and an exhaust gas storage tank 126. In one embodiment, the controller apparatus 130 includes an engine knock module 132, an exhaust gas storing module 134, an exhaust gas injection module 136, and an exhaust gas separation module 148. Further details relating to the controller apparatus 130 and a method 300 for reducing engine knock are included below with reference to FIGS. 2 and 3.

According to one embodiment, the internal combustion engine 110 includes an intake manifold 112, combustion chambers 114, and an exhaust manifold 116. The intake manifold 112 and the exhaust manifold 116 are for feeding and receiving fluid flow to and from the cylinders 114 of the internal combustion engine 110, respectively. The engine 110 can be a spark-ignited internal combustion engine, such as a gasoline fueled engine, or a compression-ignited internal combustion engine, such as a diesel fueled engine; however, engine knock is generally an issue relating to spark-ignited engines.

The system 100 may include air intake lines that direct air from the atmosphere into the internal combustion engine 110. The air intake lines may include a series of pipes or tubes through which the directed air flows. According to one embodiment, the air intake lines may be in fluid communication with a turbocharger compressor 142. Generally the air entering the intake lines is at essentially atmospheric pressure, thus a turbocharger compressor 142 can be used to increase the pressure and density of the air before introducing the air into the combustion chambers 114. The turbocharger compressor 142 is rotatably driven by the turbocharger turbine 143, which is driven by the exhaust gas stream exiting the engine 110. According to one embodiment, the air intake lines may also include an intake throttle 144 and an air cooler 146. The intake throttle 144 can control the flow-rate of air into the system 100 and the air cooler 146 cools the air prior to being introduced into the engine 110. Throughout this disclosure, the term “air” will refer to the fluid flowing in the air intake lines and into the combustion chambers 114 via the intake manifold 112. The term “exhaust gas” or “exhaust gas stream” will refer generally to the fluid flowing in the exhaust gas lines after exiting the combustion chambers 114 via the exhaust manifold 116. In other words, the composition, pressure, and temperature of the “air” and the “exhaust gas” may vary throughout the system 100 as the fluid flows through different components.

Fuel is added to the air before being combusted in the engine 110. Fuel can be added upstream of the turbocharger compressor 142, after the air exits the compressor but before entering the engine 110 (i.e. in the air intake manifold 112), or directly into the combustion chambers 114 of the engine 110 via one or more fuel injectors (not depicted). Generally, the fuel is supplied from a fuel tank and pumped through a fuel delivery system prior to being injected into the system. Whether the fuel is injected directly into the combustion chambers or injected into the air upstream of the engine, the combined fuel and air (and potentially some re-circulated exhaust gas, see below) is ignited and combusted via a spark-ignited or compression-ignited system. Combustion of the fuel produces exhaust gas that is operatively vented through the exhaust manifold 116.

The system 100 may also include an exhaust gas recirculation sub-system that includes, according to one embodiment, a compressor 124 and an exhaust gas storage tank 126. Conventional exhaust gas recirculation lines are configured to re-circulate at least a portion of exhaust gas in the exhaust manifold 116 or the exhaust lines back to the intake manifold 112 or the intake lines. Conventional exhaust gas recirculation lines can be coupled to the air intake lines at various positions and, in some instances, the recirculation lines can be directly coupled to inject exhaust gas into the combustion chambers 114.

The exhaust gas recirculation sub-system 120 of the present disclosure includes a bypass line 121 and various valves 123 that can recirculate air in substantially the same manner as conventional exhaust gas recirculation lines. In other words, when the valves 123 are configured to only direct exhaust gas flow through the bypass line 121, the exhaust gas recirculation sub-system 120 of the present disclosure functions in substantially the same manner as conventional recirculation systems. However, the valves 123 may also direct exhaust gas flow towards the compressor 124 and the exhaust gas storage tank 126. As exhaust gas passes through the compressor 124, the pressure and density of the gas increases and the exhaust gas may be subsequently stored in the exhaust gas storage tank 126. The compressor 124 may be driven by the engine 110 or may be electrically actuated via the battery, for example. The compressed gas stored in the tank 126 can be subsequently injected into the combustion chambers 114 to avoid engine knock. Additional details relating to storing the exhaust gas in the storage tank 126 and injecting the exhaust gas back into the engine 110 are included below with reference to FIGS. 2 and 3.

The exhaust gas recirculation sub-system 120 may also include a separation component 122, as depicted. The separation component 122 may be implemented in certain embodiments of the system 100 in order to separate out certain constituents of the exhaust gas stream. For example, in one implementation the separation component 122 comprises a separation membrane for separating carbon dioxide from the other exhaust gas constituents (e.g., water, nitrogen oxides, particulates, etc.). The separated carbon dioxide may be stored in the storage tank 126 and the remaining constituents can be stored in a separate tank (not depicted) or can be recirculated to the intake manifold 112 (not depicted) or can be fed into the exhaust gas aftertreatment system.

Generally, the aftertreatment system is configured to receive the exhaust gas stream generated by the internal combustion engine 110 and treat the exhaust gas stream in order to remove various harmful chemical compounds and particulate emissions before venting the exhaust stream to the atmosphere. The aftertreatment system may include one or more emissions components for treating (i.e., removing pollutants from) the exhaust gas stream in order to meet regulated emissions requirements. Generally, emission requirements vary according to engine type. As briefly discussed above, emission tests for conventional internal combustion engines typically monitor the release of carbon monoxide, unburned hydrocarbons, diesel particulate matter such as ash and soot, and nitrogen oxides.

FIG. 2 is a schematic block diagram of a controller apparatus 130 for reducing engine knock in an internal combustion engine 110, according to one embodiment. The controller apparatus 130 includes an engine knock module 132, an exhaust gas storing module 134, an exhaust gas injection module 136, and an exhaust gas separation module 138. The controller apparatus 130 is in electrical communication with the valves 123 (depicted by the dashed communication lines in FIG. 1) and various other components (communication lines to other components not depicted in FIG. 1) in the system 100. The engine knock module 132 is configured to sense the engine knock in the system 100. The engine knock module 132 may receive information from detectors and measuring devices throughout the system. For example, temperature and pressure detectors may be positioned at various locations along the intake manifold 112, the combustion chambers 114, and/or the exhaust manifold 116. The information received from such detectors may be interpreted by the engine knock module 132 in order to determine or predict when engine knock will occur. Thus, in one embodiment, the engine knock module 132 includes virtual sensors that, based on input from actual sensors that are measuring the conditions in the system, calculate the likelihood of and predict the occurrence of engine knock.

The exhaust gas storing module 134 controls the compression and storage of exhaust gas. In one embodiment, the exhaust gas storing module 134 may maintain the exhaust gas storage tank 126 at a certain pressure by periodically opening the valves 123 to charge the tank 126. In another embodiment, exhaust gas storing module 134 may charge the exhaust gas tank 126 during engine transition periods or when the engine is accelerating. During such periods, the exhaust gas may be super saturated with pollutants or the aftertreatment system may be unable to sufficiently treat the emitted pollutants to meet regulated emissions standards. For example, upon start-up, the engine components and the aftertreatment components are cold and may not adequately convert and/or treat the exhaust gas. Thus, the exhaust gas storing module 134 may determine to charge the exhaust gas storage tank 126 during these time periods in order to capture the exhaust gas with the worst emission characteristics.

In another embodiment, the exhaust gas storing module 134 may systematically and periodically charge the storage tank 126 in order to maintain a certain temperature or pressure within the tank 126. Additionally, at certain times the exhaust gas storage tank 126 may be frequently drawn from (see the description of the exhaust gas injection module below) in order to reduce knock. In such situations, the exhaust gas storing module 134 may charge the tank more frequently in order to maintain a certain pressure threshold within the tank 126.

The exhaust gas injection module 136 is configured to control the injection of exhaust gas from the tank 126 into the engine 110. As briefly described above, at various times the engine knock module 132 may measure or predict when engine knock is occurring and the engine knock module 132 may send a signal to the exhaust gas injection module 136 requesting/commanding for an injection of exhaust gas. The exhaust gas injection module 136, according to one embodiment, controls various valves and delivery sub-systems for injecting the exhaust gas into the combustion chamber 114. The exhaust gas injection module 136 may also communicate with the exhaust gas storing module 134 when the pressure in the exhaust gas storage tank 126 is low. The timing and frequency of the injection events may be based on requests or signals from the engine knock module 132 or the timing and frequency of the injection events may be based on system models that predict, based on the specifics of a given application, that periodic injections improve the operation and/or emissions of the engine 110.

The controller apparatus 130 may also include an exhaust gas separation module 138. As described above, in some embodiments it may be preferable or advantageous to remove or isolate certain constituents from the exhaust gas stream before storing the exhaust gas in the tank 126. The exhaust gas separation module 138 is configured to control the operation of the separation component 122, according to one embodiment. For example, under certain circumstances it may be beneficial for the exhaust gas tank 26 to only include carbon dioxide as opposed to the other constituents of the exhaust gas stream. The exhaust gas separation module 138 may control a separation membrane that isolates carbon dioxide from exhaust gas.

FIG. 3 is a schematic flowchart diagram of a method 300 for reducing engine knock in an internal combustion engine, according to one embodiment. The method 300 includes storing 302 exhaust gas in an exhaust gas storage tank 126, sensing 304 when engine knock occurs in an internal combustion engine 110, and injecting 306 exhaust gas stored in the exhaust gas storage tank 126 into the internal combustion engine 110 to reduce engine knock. According to another embodiment, the method 300 may further include separating 308 certain constituents of the exhaust gas before charging the exhaust gas storage tank 126.

As described above, storing 302 a portion of the exhaust gas may occur all at once, such as upon engine start-up, or the tank 126 may be periodically and/or systematically charged during operation of the internal combustion engine 110. The valves 123 involved with controlling the flow of exhaust gas to the tank 126 may be opened for a certain period of time in order to allow a specific amount of exhaust gas to flow into the compressor 124. During this step in the method, the compressor 124 may also be operating to increase the density of the exhaust gas, thus increasing the amount of exhaust that can be stored in the tank 126.

The method 300 also includes sensing 304 the occurrence of engine knock. As described above, the system 100 may include actual sensors that measure system conditions. The data collected by the actual sensors may then be analyzed using algorithms and system models for predicting when engine knock will occur. The method 300 further includes injecting 306 the exhaust gas into the combustion chambers 114. This step in the method may be triggered by a predicted knock event or because periodic exhaust gas injection may increase the fuel efficiency and improve the emissions of the engine 110.

As will be appreciated by one skilled in the art, aspects of the present disclosure may be embodied as a module, a method, or a computer program product. Accordingly, aspects of the presently disclosed method and modules may take the form of an entirely hardware embodiment, an entirely software embodiment (including firmware, resident software, micro-code, etc.) or an embodiment combining software and hardware aspects that may all generally be referred to herein as a “method.” Furthermore, aspects of the present modules may take the form of a computer program product embodied in one or more computer readable medium(s) having computer readable program code embodied thereon.

Many of the functional units described in this specification have been labeled as steps in a method or modules, in order to more particularly emphasize their implementation independence. For example, a module may be implemented using a hardware circuit comprising custom VLSI circuits or gate arrays, off-the-shelf semiconductors such as logic chips, transistors, or other discrete components. A step in the module may also be implemented using programmable hardware devices such as field programmable gate arrays, programmable array logic, programmable logic devices or the like.

Modules may also be implemented using software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where modules are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Furthermore, the described features, structures, or characteristics of the subject matter described herein may be combined in any suitable manner in one or more embodiments. In the following description, numerous specific details are provided, to provide a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for reducing engine knock, the system comprising:
an internal combustion engine;
an exhaust gas recirculation sub-system fluidly connected to the internal combustion engine, the sub-system comprising:
an exhaust gas compressor, and
an exhaust gas storage tank fluidly connected to the exhaust gas compressor; and
a controller apparatus in electrical communication with the exhaust gas recirculation sub-system that controls injecting compressed exhaust gas to the internal combustion engine to reduce engine knock.

2. The system of claim 1, wherein the exhaust gas recirculation sub-system further comprises a separation component.

3. The system of claim 2, wherein the separation component comprises a separation membrane configured to separate carbon dioxide from other exhaust gas.

4. The system of claim 2, wherein the separation component is positioned so as to selectively permit carbon dioxide to be stored in the exhaust gas storage tank.

5. The system of claim 1, wherein the exhaust gas recirculation subsystem further comprises at least one valve, the at least one valve configured to selectively direct exhaust gas to the exhaust gas compressor for compression and storage in the exhaust gas storage tank.

6. The system of claim 5, wherein the controller apparatus is configured to selectively actuate the at least one valve so as to maintain the exhaust gas storage tank at a designated pressure.

7. The system of claim 1, wherein the controller apparatus is configured to selectively charge the exhaust gas storage tank with compressed exhaust gas during periods in which a vehicle associated with the system is accelerating.

8. The system of claim 1, wherein the controller is configured to:
measure that engine knock is occurring; and
in response to measuring that engine knock is occurring, control the injection of compressed exhaust gas from the exhaust gas storage tank into a combustion chamber of the internal combustion engine.

9. The system of claim 1, wherein the controller is configured to:
predict that engine knock is occurring; and
in response to predicting that engine knock is occurring, control the injection of compressed exhaust gas from the exhaust gas storage tank into a combustion chamber of the internal combustion engine.

10. A controller apparatus for reducing engine knock, the controller apparatus comprising:
an engine knock module configured to sense engine knock in an internal combustion engine;
an exhaust gas storing module configured to compress and store exhaust gas; and
an exhaust gas injection module configured to inject compressed exhaust gas into the internal combustion engine when the engine knock module senses engine knock.

11. The controller apparatus of claim 10, further comprising an exhaust gas separation module configured to separate exhaust gas into various constituents.

12. The controller apparatus of claim 11, wherein the exhaust gas separation module is configured to separate carbon dioxide from the exhaust gas.

13. The controller apparatus of claim 10, wherein the engine knock module is configured to calculate a likelihood of engine knock occurring.

14. The controller apparatus of claim 13, wherein the engine knock module uses data collected by a plurality of sensors in calculating the likelihood of engine knock occurring.

15. The controller apparatus of claim 10, wherein the exhaust gas storing module is configured to selectively charge an exhaust gas storage tank with compressed exhaust gas during periods in which a vehicle associated with the internal combustion engine is accelerating.

16. A method for reducing engine knock, the method comprising:
storing exhaust gas in an exhaust gas storage tank;
sensing when engine knock occurs in an internal combustion engine;
injecting exhaust gas stored in the exhaust gas storage tank into the internal combustion engine to reduce engine knock.

17. The method of claim 16, further comprising separating certain constituents of the exhaust gas before storing the exhaust gas in the exhaust gas storage tank.

18. The method of claim 17, wherein carbon dioxide is separated from other constituents of the exhaust gas.

19. The method of claim 16, further comprising compressing the exhaust gas before storing the exhaust gas in the exhaust gas storage tank.

20. The method of claim 19, further comprising actuating at least one valve so as to route the exhaust gas for compression and subsequent storage in the exhaust gas storage tank.

21. The method of claim 20, further comprising selectively actuating the at least one valve so as to maintain the exhaust gas storage tank at a designated pressure.

22. The method of claim 16, further comprising selectively charging the exhaust gas storage tank during periods in which a vehicle associated with the internal combustion engine is accelerating.

23. The method of claim 16, wherein the sensing of when engine knock occurs includes using data collected by a plurality of sensors to calculate a likelihood of engine knock occurring.
